(19) United States
(12) Patent Application Publication
(10) Pub. No.: US 2015/0342212 A1
(43) Pub. Date: Dec. 3, 2015

(54) Pill Drink

(71) Applicant: Paul Yang, Vernon, CA (US)

(72) Inventor: Paul Yang, Vernon, CA (US)

(21) Appl. No.: 14/289,658

(22) Filed: May 29, 2014

(51) Int. Cl. A23F 5/24; A23F 5/38

(52) U.S. Cl. CPC A23F 5/243; A23F 5/385

(57) ABSTRACT

A portable instant coffee system that utilizes cellulose-based, water-soluble, or squeezable pills or tablets is enclosed. The system includes at least two components: one coffee extract pill or tablet and a flavor enhancing pill or tablet. The flavor enhancing pill or tablet can be a sweetener or creamer. Additional tablets can be the other type of flavor enhancer. The system can also include a tablet that will give the drink an effervescent quality.

### BACKGROUND OF THE INVENTION

1. Field of the Invention

Ever since the advent of coffee as a method to quickly awaken the minds and bodies of individuals everywhere, there have been multiple developments in the preparation and delivery of the caffeinated beverage. While there are numerous ways of brewing the perfect cup, many consumers have been seeking a quicker and more portable alternative to the preparation of their coffee beverage. The need for this quicker and more portable cup of coffee has led to numerous developments in the field of instant coffee and coffee drinks. The most common of which are powdered forms of coffee in which the user provides hot water and adds the powder into his or her own cup. However, this and other types of instant coffee suffer from the same limitation—the user can only alter the potency and taste of their coffee via the dilution of an already set flavor palate.

The present invention relates to the technical field of instant drinks. More particularly, the present invention relates to the technical field of instant drinks via additives to water.

The present invention provides an alternative to powdered instant coffee and also provides a portable alternative to carbonated beverages.

2. Description of the Related Art

Erik Peter Schokker et al., Encapsulated Edible Liquids, WO/2009/022909 (Pub. Feb. 19, 2009). Schokker's invention involves a capsule made of edible material and holding an oil-in-water emulsion. Schokker's invention has a different application—for use in foods. Also, Schokker makes a reference for its use to flavor liquids. Here, the invention provides not only flavoring, but also the integral component of the coffee as well.

Constance Pauline Francis and Cristi Dianne Cottle, Dissolvable flavoring capsules, US20040185150 (Pub. Sep. 23, 2004). Francis and Cottle's invention involves a “dissolvable flavoring capsule” but differs in his application—he uses gelatin capsules, as opposed to cellulose-based capsules, as a method of flavoring food, as opposed to beverages.

David F. Hinkley, Self-Dissolving Instant Coffee Tablets, U.S. Pat. No. 2,889,226. Hinkley's invention involves self-dissolving coffee tablets that are limited by a composition of sodium bicarbonate and alginic acid. This present invention is a coffee beverage system and can utilize a variety of different tablet compositions.

Nicolas Madit (Pfizer), Liquid filled delivery system, preferably an HPMC capsule filled with glycerol, WO/2007/029098 (Pub. Mar. 15, 2007). Madit's invention does use HPMC capsules to deliver liquids, but is not for the coffee or beverage market, but rather as another method to deliver liquid medication.

Daniele Fregonese and Dora Zamuner, Water-soluble containers, US20050089659 (Pub. Apr. 28, 2005). Fregonese and Zamuner's invention focuses on the use of HPMC and like materials for water-soluble capsules housing cleaning detergents used in laundry machines. It is not for the same application in coffee or other beverages as the present invention.

Lowell A. Sanker, Liezl G. Peterson, James G. Upson, Beadlets for customization of flavor and sweetener in a beverage, U.S. Pat. No. 5,620,707 (Apr. 15, 1997). This invention is for a water-soluble beadlet that houses a sweetener within its core. It is mainly used for flavoring coffee and other beverages. This invention differs from the present invention in that the invention discloses a shell made of either a polyvinyl alcohol, gelatin, waxes, gums, and sugar candies. These are different from that of the present invention, in which a cellulose-based capsule is used. In addition, this invention, while it includes a flavoring component, also includes the core component of the beverage itself—the coffee extract.

Donald Spector, Pill and method of adding measured quantities of ingredients to bottled water, 20070158232 (Pub. Jul. 12, 2007). Spector's invention is for water-soluble pills that provide flavoring and additives to a bottle of water. It differs from the present invention in that the pills hold powders. Spector's invention focuses on answering the question of the messiness of powders through the use of a soy-based membrane, whereas this present invention focuses on utilizing water-soluble characteristics of a cellulose coating to deliver liquid extracts to water.

David F. Hinkley, Self-Dissolving Instant Coffee Tablets, U.S. Pat. No. 2,889,226 (Jun. 2, 1959). Hinkley's invention is similar to an embodiment of this present invention. However, they differ in that this system may utilize tablets that are not homogenous mixtures of coffee and sweetener. The present invention's composition is with coffee and sweetener on the same pill but separate. Furthermore, the present invention is a system of instant coffee in which several tablets may be used in order to produce the user's final beverage.

### SUMMARY OF THE INVENTION

This present invention is a new beverage system. The system involves the use of pills in gel capsule, tablet, or similar form. Each pill contains concentrated liquid extract. Each pill's content is capable of either dissolving in water or being squeezed out into the water for quicker dissolution. Capsules can be added according to the flavor or concentration preferences of the user. In addition, each capsule is environmentally friendly due to the biodegradable nature of its case. The current invention allows for higher beverage portability for such beverages as coffee and carbonated beverages. The system provides the user a coffee or other beverage through the use of the user's own provided drinking water (whether hot or cold). The additives are in the form of concentrated extracts within pills in either capsule or tablet form. The system utilizes several different pills depending on the user's preference in drink.

### BRIEF DESCRIPTION OF THE DRAWINGS

FIG. 1 shows an embodiment of a completed package of the system. It includes four different pills. Three pills are HPMC-coated gel capsules. The far left capsule contains highly concentrated liquid coffee extract at or about 200 mg. The capsule to the right of the coffee capsule holds liquid sugar or a sugar substitute. The capsule third from the left includes liquid cream or other flavors. The final pill includes carbonation ingredients that will allow the user to add carbonation to his or her coffee.

FIG. 2 shows one example of a gel capsule containing coffee. The liquid is located within the pill. The pill can be broken in the middle through a twisting action. The actual size of the pill is shown to be ¾ inches by 2 inches with a depth of ⅜ inches to ½ inches.

FIG. 3 shows another embodiment of the invention, in which the coffee extract is contained within a dissolvable pill.

### DETAILED DESCRIPTION OF THE INVENTION

This invention utilizes dissolvable pills. Some of the pills can be capsules made of a hypromellose or hydroxypropyl methylcellulose (“HPMC”) coating. Each cellulose-based or HPMC capsule contains a liquid, which is integral to either the beverage to be consumed or adds to the flavor. By varying capsules, the user can tailor his or her beverage to his or her own taste preferences.

An embodiment of this system includes three cellulose-based capsules—each capsule being biodegradable and dissolvable within hot water. The first capsule includes concentrated liquid coffee extract. The second capsule includes either liquid sugar or a sugar substitute. The third capsule includes liquid cream or some other coffee taste enhancer. The user can add the first capsule or squeeze the content out by separating the two parts manually, after opening the pill by twisting part of the capsule, which includes liquid coffee extract, to a cup of hot water. The capsule will either dissolve releasing the coffee extract into the hot water or be directly squeezed by the user into the cup of hot water for quicker dissolution, resulting in a cup of hot coffee when the concoction is mixed. The user can choose to add or squeeze, either partially or fully, additional pills containing the coffee extract to increase the coffee content. Additional pills would enable the user to both enhance the coffee taste and the caffeine level. The user can also add or squeeze the second and third pill in whatever combination desired to comply with the user's taste preferences for sugar and cream.

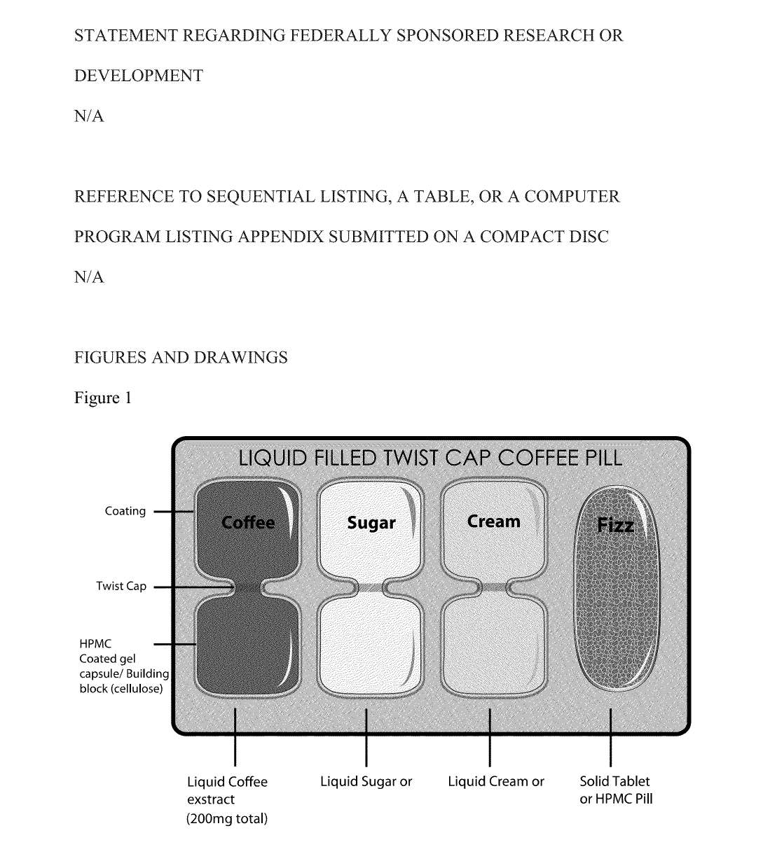

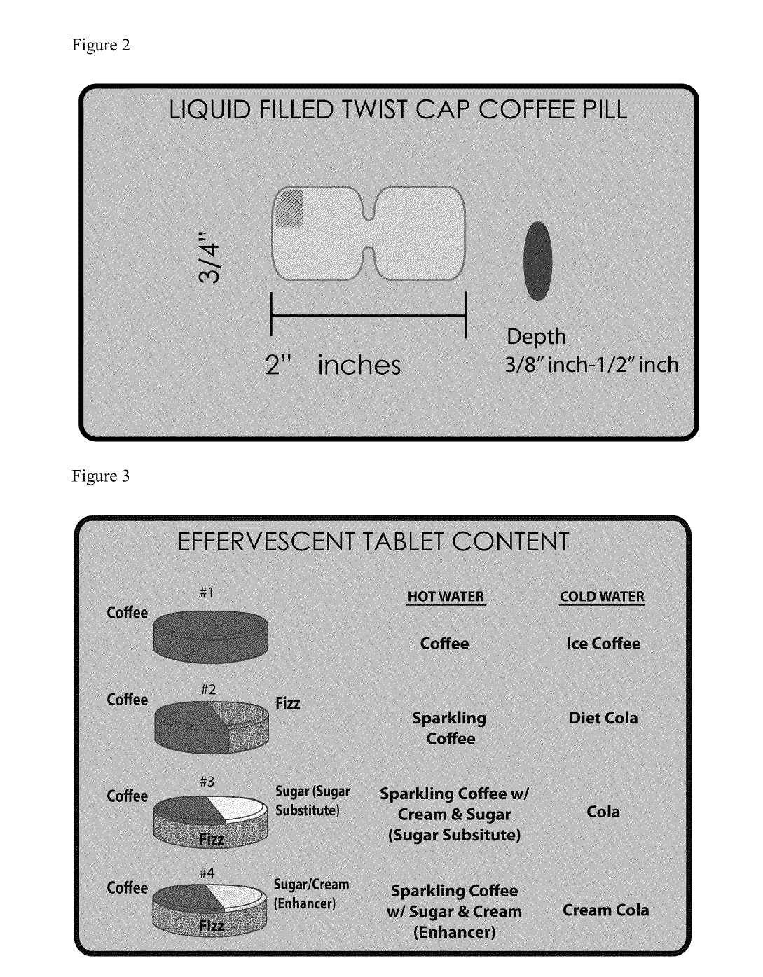

A second embodiment of this system is illustrated in FIG. 1, which includes four capsules—each capsule being biodegradable and able to dissolve in hot water. The first gel capsule contains concentrated liquid coffee extract. The second gel capsule contains either liquid sugar or a sugar substitute. The third gel capsule contains either liquid cream or another taste enhancer. The fourth capsule or tablet contains “fizz” for carbonation in the beverage. The second embodiment is for users who want an iced coffee soda. In this embodiment, the user will add or squeeze the gel capsule containing the liquid extract into a cup of cold water. The user can add or squeeze the additional capsules to enhance the coffee content of the drink. Afterwards, the user can add cream or liquid capsules according to his or her taste preferences. And finally, the user can add the final “fizz” tablet or pill, which will add carbonation to the beverage.

Four more embodiments of this system are illustrated in FIG. 3. All four of these embodiments are seen as dissolvable tablets. The first (from the top) is made entirely of coffee extract. After adding hot water, the mixed-in and fully dissolved pill will produce hot coffee. If cold water is added, the mixed-in and fully dissolved pill will produce iced coffee. The second is made of half coffee and half “fizz” component. This pill will provide the user with hot sparkling coffee if hot water is added to the pill. If the user opts for cold water, the user can produce cold sparkling coffee with the pill. For this embodiment, instead of coffee extract, half of the pill can also have other components, such as cola extract. This will allow the user to produce a cola drink when cold water is added to the pill. The third tablet is comprised of coffee, “fizz” component, cream, and a sugar substitute. This particular embodiment is for the user who wants an artificially-sweetened, “diet” sparkling coffee drink. The user can either add hot or cold water dependent on his or her preferences. Much like the second tablet, this tablet can substitute the coffee extract for cola extract instead so that the user can have a diet cola when cold water is added. The fourth tablet is similar to the third tablet in that it comprises of coffee extract, “fizz” or effervescent component, cream, and some type of flavor enhancer. However, in this embodiment, the tablet contains sugar. Through this tablet, the user can have the more traditional coffee with sugar and cream.

1. An instant coffee system, comprising of a coffee extract in a dissolvable pill and flavoring in a dissolvable pill.

2. An instant coffee system according to claim 1, wherein the dissolvable pill is a cellulose-based gel capsule.

3. An instant coffee system according to claim 2, wherein the cellulose-based gel capsule is made of hypromellose or hydroxypropyl methylcellulose (“HPMC”) material.

4. An instant coffee system according to claim 1, wherein the flavoring is liquid an sugar, sugar substitute.

5. An instant coffee system, comprising of a coffee extract in a cellulose-based gel capsule, flavoring in a cellulose-based gel capsule, and ingredients for adding carbonation to a drink in a pill or tablet.

6. The instant coffee system of claim 5, whereas the pill or tablet for the carbonation ingredients is made of a cellulose-based gel capsule.

7. An instant coffee system, comprising of a coffee extract in a dissolvable tablet and flavor enhancer in a dissolvable tablet.

8. The coffee system of claim 7, further comprising an additional flavor enhancer tablet.

9. (canceled)
